(19) United States
(12) Patent Application Publication
(10) Pub. No.: US 2023/0134546 A1
(43) Pub. Date: May 4, 2023

(54) NETWORK THREAT ANALYSIS SYSTEM

(71) Applicant: Oracle International Corporation, Redwood Shores, CA (US)

(72) Inventors: Venkatakrishnan Gopalakrishnan, Ontario (CA); Ján Sterba, Bratislava (SK); May Bich Nhi Lam, San Jose, CA (US); Yunjiao Xue, CA (US); Nana Lei, San Francisco, CA (US); Edward C. Cheng, South San Francisco, CA (US); Hayward Ivan Craig Welcher, Waterloo (CA); Jacob Becker West, San Francisco, CA (US); Qi Wen Cao, Ontario (CA)

(73) Assignee: Oracle International Corporation, Redwood Shores, CA (US)

(21) Appl. No.: 17/452,837

(22) Filed: Oct. 29, 2021

(51) Int. Cl. H04L 29/06; G06N 5/02; G06N 5/00

(52) U.S. Cl. CPC H04L 63/1425; H04L 63/1441; G06N 5/022; G06N 5/003; H04L 2463/082; H04L 63/0838; H04L 63/10

(57) ABSTRACT

Machine-learning techniques and models are described for alerting users to attacks on accounts in real-time or near real-time. In some embodiments, an attack detection model uses Natural Language Processing (NLP) and multi-level classification techniques to monitor login attempts and detect attacks. The model may use NLP to convert text associated with account activity to numerical vectors, where the vectors include scores and/or other numerical values computed based on the meaning of the converted text. The model may further include a set of classifiers trained to learn patterns in the numerical vectors that are predictive of a network attack. The model may assign labels to events based on the predicted likelihood that the event is an attack. The system may deploy real-time preventative or corrective measures based on the ML model output to counter or mitigate the effects of an attack.

### TECHNICAL FIELD

The present disclosure relates to network attack detection, prevention, and mitigation. In particular, the present disclosure relates to using machine learning to adaptively predict and prevent attacks on accounts accessible over a network.

### BACKGROUND

A network attack is an attempt to gain unauthorized access to a set of computing resources that are accessible over a network. Successful network attacks may allow unauthorized parties to view and copy sensitive data, thereby compromising data security. In more severe cases, attackers may modify, encrypt, or otherwise corrupt data. Data breaches may lead to serious repercussions for individuals and organizations, including liability stemming from the loss or unauthorized use of private data.

Network administrators may deploy preventative measures to counter network attacks. For example, network administrators may set a threshold number of password attempts before locking a user account, install antivirus software to monitor the network for viruses, and encrypt sensitive data to reduce the likelihood of unauthorized access. However, network attacks are constantly evolving, and it may be difficult to anticipate every attack technique.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example system for network threat analysis in accordance with some embodiments.

FIG. 2 illustrates an example set of operations for converting textual tokens to numerical values in accordance with some embodiments;

FIG. 3 illustrates an example conversion of log data to numerical scores in accordance with some embodiments;

FIG. 3 illustrates an example set of operations for training a machine-learning model to adaptively predict network attacks in accordance with some embodiments;

FIG. 4 illustrates an example set of operations for training a machine-learning model to perform real-time monitoring of network attacks in accordance with some embodiments;

FIG. 5 illustrates an example set of operations for tuning a machine-learning model to perform real-time monitoring of network attacks in accordance with some embodiments;

FIG. 6 illustrates an example set of operations for applying a machine-learning model to perform real-time monitoring of network attacks in accordance with some embodiments;

FIG. 7 illustrates an example application of a model for analyzing a network threat associated with an event in accordance with some embodiments; and

FIG. 8 illustrates a computer system in accordance with some embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

1. GENERAL OVERVIEW

2. SYSTEM ARCHITECTURE FOR NETWORK THREAT ANALYSIS

3. MODELS FOR NETWORK THREAT MONITORING
3.1 NLP-BASED FEATURE ENGINEERING
3.2 CLASSIFIER TRAINING
3.3 MODEL EVALUATION AND TUNING

4. REAL-TIME THREAT ANALYSIS AND DETECTION

5. REAL-TIME ATTACK RESPONSES AND MITIGATION

6. COMPUTER NETWORKS AND CLOUD NETWORKS

7. MICRO SERVICE APPLICATIONS

8. HARDWARE OVERVIEW

9. MISCELLANEOUS; EXTENSIONS

1. General Overview

Machine-learning techniques and models are described for alerting users to attacks on accounts in real-time or near real-time. In some embodiments, an attack detection model uses Natural Language Processing (NLP) and multi-level classification techniques to monitor login attempts and detect attacks. The model may use NLP to convert text associated with account activity to numerical vectors, where the vectors include scores and/or other numerical values computed based on the meaning of the converted text. The model may further include a set of classifiers trained to learn patterns in the numerical vectors that are predictive of a network attack. The model may assign labels to events based on the predicted likelihood that the event is an attack. The system may deploy real-time preventative or corrective measures based on the model output to counter or mitigate the effects of an attack.

During a training phase, a machine-learning (ML) engine may receive a training dataset including a plurality of examples of user log events associated with one or more user accounts. The ML engine may use the training dataset for training the attack detection model to learn atypical behavior that is predictive of attacks, including the type and severity of the network attacks. The training process may use NLP during feature extraction and engineering to transform text included in the examples into a set of numerical vectors. The numerical vectors may include scores for words based on what the word means to a log entry versus what the word means to a list of historical events, such as all events in the past three to five days. The ML engine may then construct one or more ML classification models as a function of the varying feature values, including the varying NLP-based scores, to learn what behavior associated with log events is most predictive of a network attack.

In some embodiments, the ML engine may construct ML models on a per account basis. By constructing separate ML models for different accounts, the system may learn different prototypical behaviors for various users. Behavior that is atypical for one user may not be atypical for another user. Additionally or alternatively, the number and/or severity of likely attacks may vary for different users even when exhibiting similar behavior. Machine learning allows for prototypical behaviors to be learned at application runtime, thereby avoiding hard-coded rules which may not be universally applicable to all user accounts. The ML model may further evolve as prototypical behavior changes over time, adapting to new attack techniques. The ML model may be periodically or continuously retrained as new behavior is observed.

During an inference phase, the ML engine may generate predictions by applying the trained ML model to newly generated log data associated with a user account. When applying the model, the ML engine may perform feature extraction and transformation to generate a feature vector in the same manner as the training phase. For example, the ML engine may use NLP to convert log text to numerical vectors and apply a trained classifier to the numerical vectors to generate a prediction. The newly observed data may be unique, not exactly matching any previous examples in the training dataset due in part to the extremely large number of possible permutations of the extracted feature values. The ML model may receive the feature vector as input and output a set of one or more predictions about whether observed behavior is a network attack.

A system may use the ML model predictions to provide analytic insights and/or trigger responsive actions to address attacks in real-time. For example, the system may generate real-time alerts that identify accounts where the ML model has detected a network attack. Additionally or alternatively, the system may implement preventative actions at runtime, including selectively enabling or disabling security measures on an account-by-account basis based on the predicted network attack risks.

One or more embodiments described in this Specification and/or recited in the claims may not be included in this General Overview section.

2. System Architecture for Network Threat Analysis

In some embodiments, a network threat analysis system provides real-time monitoring of a set of user accounts for accessing one or more network services and/or one or more networked computing resources. A user account may provide a mechanism through which a system identifies, tracks, and/or authenticates distinct users. A user may log into a user account through an authentication process, which may require the user to submit a password and/or other authentication credentials. Once logged in, the user may access files, applications, and/or other resources that the user is authorized to access.

In some embodiments, each user account is associated with a different home directory, which may serve as the root directory for a corresponding user account and store files generated based on the activity of a user logged into the user account. Access to a root directory may be restricted to the corresponding user account and one or more administrator accounts, thereby preventing unauthorized access to a user's files by other users of a network service. Further, when a user is logged in to a user account, the system may constrain user access to the root directory associated with the user account to prevent unauthorized access to private system resources.

In some embodiments, the set of user accounts may include accounts to access one or more cloud services. A cloud service may include computing infrastructure, platforms, and/or software that are hosted by a third-party service provider and made available through the internet. Example cloud service models include software-as-a-service (SaaS), database-as-a-service (DBaaS), platform-as-a-service (PaaS) and infrastructure-as-a-service (IaaS). Users may create an account as part of a subscription with one or more cloud services.

In some embodiments, cloud services may allow subscribing entities to build and deploy network services that are accessible to other users. For example, a cloud service may host software and/or hardware resources provisioned to a subscriber for customizing and launching an e-commerce website. Online shoppers may visit and create separate accounts to access the website and/or subscribe to an online service. Thus, a primary subscriber account may manage or otherwise be associated with a plurality of shoppers, secondary subscribers, and/or other users accounts that have access to an online service created by the primary subscriber using the provisioned cloud resources, resulting in a multi-level hierarchy of user accounts. The network attack monitoring techniques may be applied to one or more levels of user accounts as described further herein.

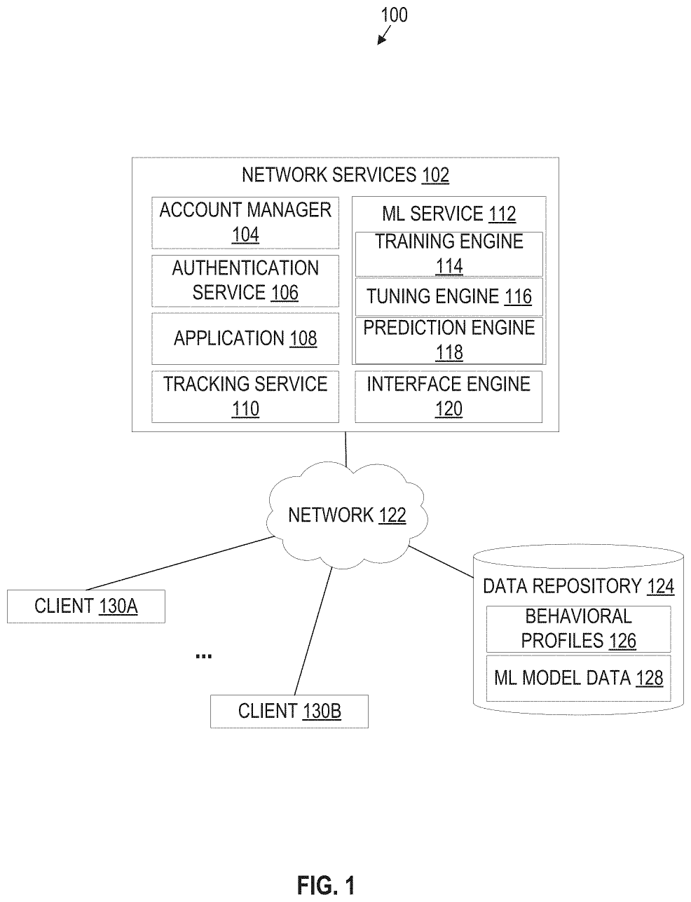

FIG. 1 illustrates an example system for network threat analysis in accordance with some embodiments. As illustrated in FIG. 1, system 100 includes network services 102, network 122, data repository 124, and clients 130a-b. System 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In some embodiments, network services 102 includes a set of hardware and/or software resources that are accessible via network 122. Network services 102 may represent one or more cloud services, such as IaaS, PaaS, DBaaS, and/or SaaS applications. Additionally or alternatively, network services 102 may include a set of components for managing a set of user accounts for identifying, tracking, and/or authenticating distinct users. The set of components may include account manager 104, authentication service 106, applications 108, tracking service 110, ML service 112, and interface engine 120. As previously mentioned, the components within system 100, including network services 102 may vary. In some cases, a function performed by one component may be combined or otherwise implemented by another component within system 100. Additionally or alternatively, the components of networks services 102 may execute locally or remotely from one another.

In some embodiments, account manager 104 manages user accounts that have access to network services 102. For example, account manager 104 may manage the creation of new user accounts as users subscribe to a service and the deletion of accounts. Additionally or alternatively, account manager 104 may assign identifiers that uniquely identify distinct user accounts. Additionally or alternatively, account manager 104 may manage other aspects of a user account, such as privacy settings, identity and access management (IAM) policies, and user account access authorizations.

Once a user account is created, users may log in to the user account when successfully authenticated by authentication service 106. In some embodiments, authentication service 106 implements one or more authentication protocols to verify user identities. Example authentication protocols include the password authentication protocol (PAP), the challenge-handshake authentication protocol (CHAP), and authentication, authorization, and accounting (AAA) protocols. During a login attempt, users may submit a username, password, digital certificate, and/or other credentials. Authentication service 106 may check the credentials and block the login attempt if the credentials are not successfully verified.

If the credentials are successfully authenticated, the user may be granted permission to access a restricted set of network resources, such as application 108, which may comprise software and/or services to perform tasks directed by the end user. For example, an SaaS application may include software and services to manage customer relations, operations, social media, inventory, website design, and/or e-commerce functions. However, the application-specific functions may vary depending on the network service and/or the user subscription.

Tracking service 110 may generate logs that track the activity of users logged into and/or attempting to log into user accounts. In some embodiments, tracking service 110 includes one or more monitoring agents, such as daemons and/or log-generating processes, that trace or otherwise capture user requests. For example, tracking service 110 may track the number of directory traversals, the number of standard query language (SQL) injection attempts, the number of successful login attempts, the number of failed login attempts, the location of login attempts, and/or the number of vulnerability scans triggered with respect to one or more user accounts. Additionally or alternatively, other metrics may be logged by tracking service 110 to track the behavior of online users.

In some embodiments, ML service 112 includes components for profiling user behavior and learning what behavioral patterns are predictive of future network attacks. ML service 112 may make inferences and adjustments during application runtime rather than relying on static instruction sets to perform tasks. Thus, system 100 may adapt in real-time to varying and evolving behaviors indicative of attacks without requiring addition hard-coding of new attack patterns.

In some embodiments, ML service 112 includes training engine 114 for training ML models, tuning engine 116 for adjusting ML model parameters and/or hyperparameters, and prediction engine 118 for applying trained ML models. Techniques for training and tuning ML models are described further in Section 3, titled Models for Network Threat Monitoring.

Interface engine 120 may provide a user interface for interacting with network services 102. Example user interfaces may comprise a graphical user interface (GUI), an application programming interface (API), a command-line interface (CLI) or some other interface for accessing network resources. Interface engine 120 may serve interface components to client applications, including clients 130a-b, which may render the elements in a display. For example, a client may be a browser, mobile app, or application frontend that displays user interface elements for invoking one or more of network services 102 through a GUI window. Examples of user interface elements include checkboxes, radio buttons, dropdown lists, list boxes, buttons, toggles, text fields, date and time selectors, command lines, sliders, pages, and forms.

Users may use clients 130a-b, which may include client applications and/or devices, to connect with network services 102 via network 122. Network 122 represents one or more interconnected data communication networks, such as the internet. Clients may connect with network services 102 according to one or more communication protocols. Example communication protocols may include the hypertext transfer protocol (HTTP), simple network management protocol (SNMP), and other communication protocols of the internet protocol (IP) suite.

In some embodiments, the network resources include data repository 124. Data repository 124 may include volatile and/or non-volatile storage for storing behavioral profiles 126 and ML model data 128. Behavioral profiles 126 may include metrics and learned patterns representing typical user behavior for one or more user accounts. ML model data 128 may store model artifacts and outputs. For example, ML model data 128 may store weights, biases, hyperparameter values, and/or other artifacts obtained through model training. Additionally or alternatively, ML model data 128 may include predictions and/or other values from obtained from evaluating and applying a trained ML model.

In some embodiments, the ML model predictions and related functions are exposed through a cloud service or a microservice. A cloud service may support multiple tenants, also referred to as subscribing entities. A tenant may correspond to a corporation, organization, enterprise or other entity that accesses a shared computing resource. Different tenants may be managed independently even though sharing computing resources. For example, different tenants may have different account identifiers, access credentials, identity and access management (IAM) policies, and configuration settings. Additional embodiments and/or examples relating to computer networks and microservice applications are described below in Section 6, titled Computer Networks and Cloud Networks, and Section 7, titled Microservice Applications.

3. Models for Network Threat Monitoring

3.1 NLP-Based Feature Engineering

In some embodiments, ML service 112 generates a set of feature vectors for training an ML model. A feature vector may include a set of values for various features that capture behavioral attributes associated with a user account. For example, a feature vector \hat{x} may be represented as [x₁, x₂, . . . , xₙ], where x₁ is the value for a first feature, x₂ is the value for a second feature, and xₙ is the value for the n^{th} feature.

The features that are selected for training and the number of features in the vector may vary depending on the particular implementation. One or more features may be curated by a domain expert. Additionally or alternatively, ML service 112 may select one or more features during the training and/or tuning phase based on which features yield an ML model with the highest performance. ML service 112 may extract, generate, and/or select features based on the activity tracked by tracking service 110.

In some embodiments, the set of features includes values extracted from log data associated with a user account. User activity, such as login attempts, may trigger tracking service 110 to generate login data that captures attributes associated with the activity. For example, the log data may include one or more of the attributes shown in Table 1 below.

TABLE 1
SAMPLE EVENT LOG ATTRIBUTES

| Event Log Attribute | Description |
|---|---|
| IP address | Identifies an IP address associated with a login attempt |
| _time | Includes a timestamp indicating when a login attempt occurred |
| alertType | Identifies a result and/or classification of a login attempt |
| compid | Identifies an internal identifier for a customer |
| city | Identifies a city used for login derived from the IP address |
| country | Identifies a country user for login derived from the IP address |
| hostname | Identifies a name for a server processing the request |
| owningMolecule | Identifies an environment associated with the request (e.g., |
| | production, future, snap, dev, etc.) |
| owningCluster | Identifies a functioning module associated with the request |
| | (e.g., shopping, accounting, webservice, debug, etc.) |
| Host | Identifies a host uniform resource locator (URL) from the |
| | request header information |
| origin | Identifies a domain from which the request originated |
| referer | Identifies the last page or the page from which the requester |
| | was directed |
| method | Identifies request methods that indicate the desired action to be |
| | performed |
| protocol | Identifies a network protocol associated with the request |
| scheme | Identifies the protocol to be used |
| JSESSIONID | Identifies a cookie, already hashed by system (5 char replaced by *) |
| accept | Identifies media types that are acceptable for the response |
| path | Identifies the specific resource in the host that the user/web client |
| | wants to access |
| timestamp | Identifies a login timestamp |
| properties.geoip.isp.organization | Identifies a network provider used for login |
| state.login.email | Identifies an email used for login |
| user_agent | Identifies a browser used for login |
| language | Identifies a language used for login |

The example event log attributes capture various aspects about the behavior of a login attempt. Additionally or alternatively, other attributes associated with account activity may be extracted and used as features to build an ML model.

In some embodiments, ML service 112 includes an NLP engine that converts text-based features into numerical values. For instance, a numerical value for a token may be a score that represents what the word means to the log entry versus what the word means to a list of historical events. An example approach for assigning a score is to compute a term frequency inverse-document frequency (TF-IDF) score. With TF-IDF, the score for a token increases proportionally to the frequency the token appears in a log record offset by the number of logs that include the token. The TF-IDF score may be computed on a per-account basis to account for varying user behaviors.

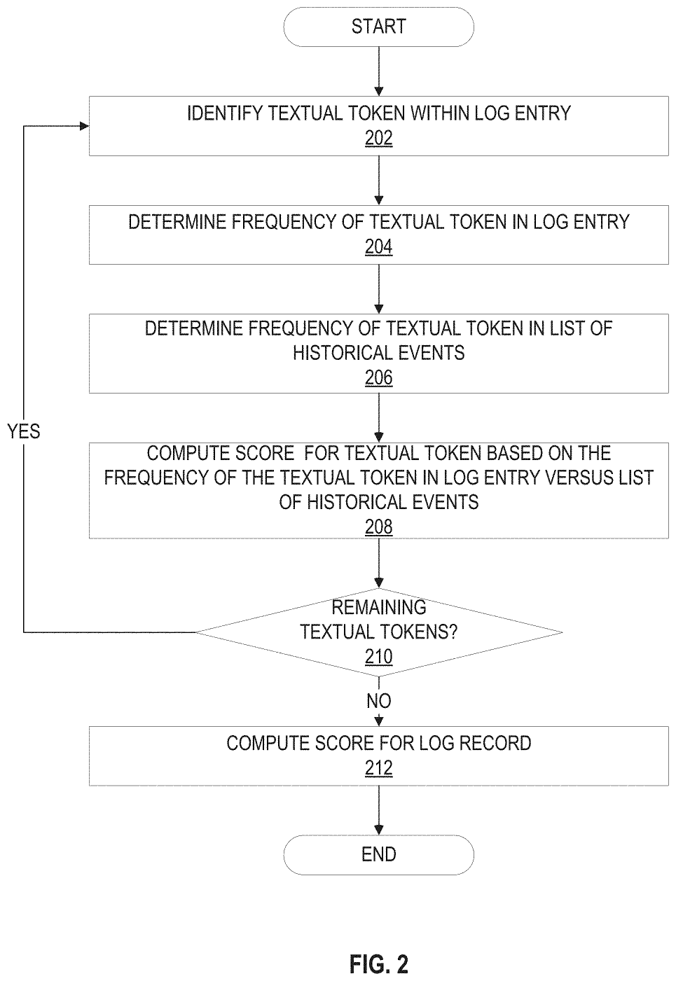

FIG. 2 illustrates an example set of operations for converting textual tokens to numerical values in accordance with some embodiments. One or more operations illustrated in FIG. 2 may be modified, rearranged, or omitted all together. Accordingly, the particular sequence of operations illustrated in FIG. 2 should not be construed as limiting the scope of one or more embodiments.

Referring to FIG. 2, the process includes identifying a textual token within a log entry (operation 202). For example, the process may extract one or more of the attribute values listed above in Table 1 for a recent or historical login attempt. A textual token as used herein may include words and/or phrases. Additionally or alternatively, a textual token may include numeric values in a string format. For instance, an IP address and timestamp may include numeric values. The process may generate scores based on the frequency and/or uniqueness of the tokens as described further herein.

The process next determines a frequency of the textual token in the log entry (operation 204). For example, the process may compute a term frequency for a token as the number of repetitions of the token in the log entry divided by the total number of tokens in the log entry. In some embodiments, a weighting scheme may be applied, such as a logarithmic scaling or an augmented frequency to prevent a bias toward longer log entries. However, unweighted frequency values may also be used, depending on the particular implementation.

The process further determines a frequency of the textual token in a list of historical events (operation 206). For example, the process may determine a frequency of the token in a list of log records in the past five days or over some other timeframe. A logarithmically scaled inverse document frequency may be computed by taking the log of the value obtained by dividing the total number of log entries within the specified timeframe by the number of log entries include the token.

In some embodiments, the process computes a score for the textual token based on the frequency of the textual token in the log entry versus the list of historical events (operation 210). For example, a TF-IDF score for a token may be computed as the product of the token frequency and the inverse log record frequency.

The process further determines whether there are any remaining textual tokens in a log entry to analyze (operation 210). If so, then the process may iterate through the remaining textual tokens to compute scores for the tokens.

In some embodiments, the process computes a score for the log record based on the scores of the textual tokens included in the log record (operation 212). For example, the process may sum, average, and/or otherwise aggregate the scores to compute a score for the log record. The individual and/or aggregate tokens scores may be used to train ML model classifiers, as described further below.

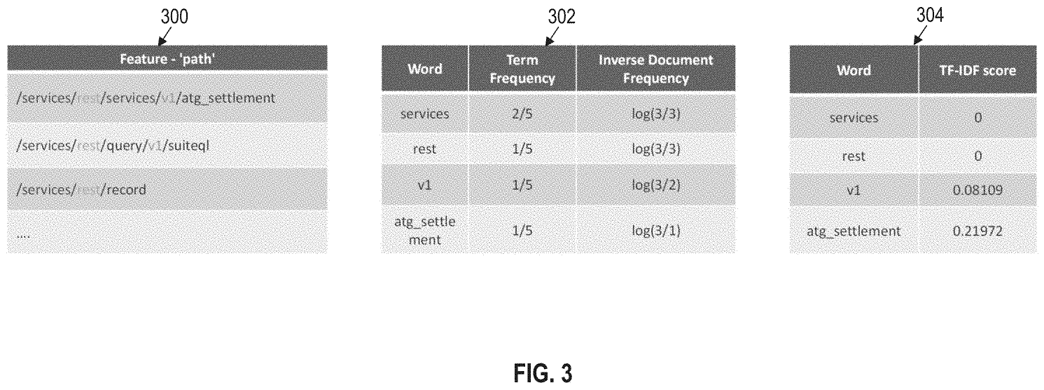

FIG. 3 illustrates an example conversion of log data to numerical scores in accordance with some embodiments. Table 300 shows an example path attribute extracted from different log records. Each path attribute includes a set of textual tokens, including services, rest, v1, and atg_settlement. Table 302 shows the term frequency and inverse document (log record) frequency values for each of the tokens, and table 304 shows the resulting score values.

3.2 Classifier Training

Training engine 114 may use a set of feature vectors associated with a user account to train one or more ML models. In some embodiments, training engine 114 trains one or more classification models that classify activity based on detected threat levels. For example, the trained classifier may assign a label of Green to activity not detected to be a network attack, Amber where a low risk of a network attack is predicted, and Red to activity with a high risk of network attack. Additionally or alternatively, other labels may be assigned, depending on the particular implementation.

The classification model that is trained may vary depending on the particular implementation. In some embodiments, training engine 114 builds one or more decisions trees, which may include random forests and/or gradient boosted trees. However, training engine 114 may train other ML classifiers such as cluster-based classifiers, support vector machines (SVMs) and/or artificial neural networks.

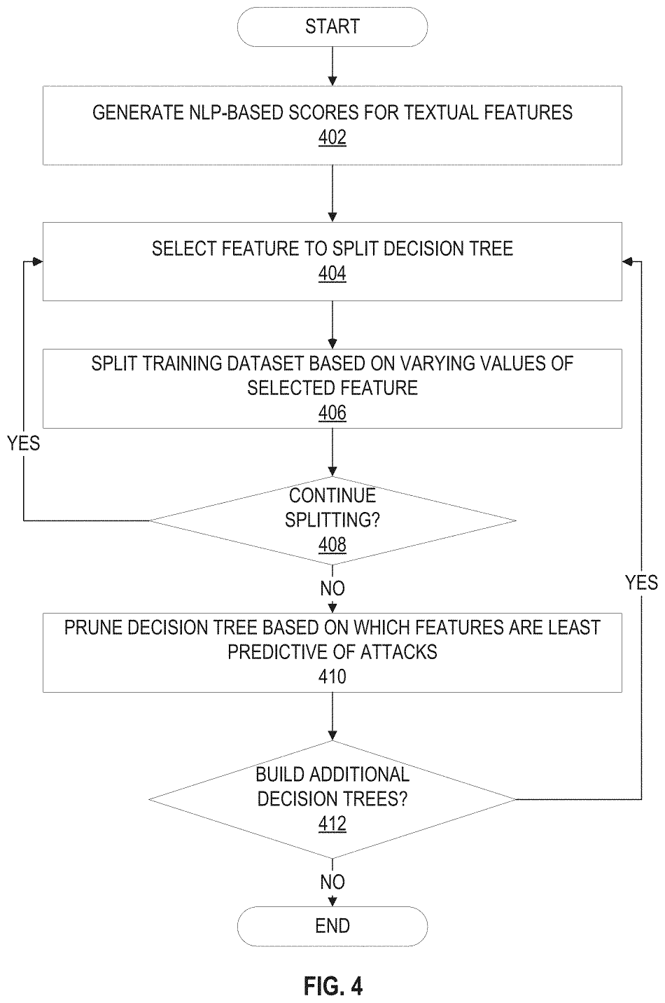

FIG. 4 illustrates an example set of operations for training a machine-learning model to perform real-time monitoring of network attacks in accordance with some embodiments. One or more operations illustrated in FIG. 4 may be modified, rearranged, or omitted all together. Accordingly, the particular sequence of operations illustrated in FIG. 4 should not be construed as limiting the scope of one or more embodiments.

Referring to FIG. 4, the process includes generating a set of NLP-based scores for textual features in a set of log data used to train the ML model (operation 402). For example, the process may receive a set of training examples where each example includes one or more historical log records and an indication of whether a network attack occurred. The process may then generate TF-IDF scores for the individual textual tokens and/or the log records as previously described. The process may generate a feature vector for an example that includes the scores. Additionally or alternatively, the feature vector may include values for other attributes, such as the number of detected vulnerability scanners, number of directory traversals, and number of SQL injection attempts

In some embodiments, the process selects a feature to split a decision tree (operation 404). The process may select the feature to minimize the cost of an error function, such as the Gini Index function defined as E=Σ(pₐ*(1−pₐ), where pₐ represents the proportion of training examples in a particular class of a prediction node. For instance, pₐ may represent the proportion of data where an attack was detected or where a particular category of attack was detected (e.g., severe attack, moderate attack, no attack). As another example, the process may determine that a TF-IDF score of 5.1 for a particular feature minimizes the error function. However, the selected feature and feature value used to split the tree may vary depending on the particular activity detected within the account. The process may implement a greedy algorithm to identify the feature and feature value used to split the tree, although the manner in which the selection is made may vary depending on the particular implementation.

The process next splits the training dataset based on the selected feature (operation 406). For example, if a TF-IDF score of 5.1 for a particular feature is selected, then training examples with a value less than 5.1 may be assigned to one branch of the tree and greater than 5.1 to another branch of the tree. If another value and/or feature is selected, then the process splits along the learned boundary.

In some embodiments, the process determines whether to continue splitting the decision tree (operation 408). The process may continue to split the tree until a set of one or more stopping criteria are satisfied. For example, the process may split the tree until the number of examples assigned to one or more leaf nodes falls below a minimum threshold. If the stop criteria are not satisfied, then the process may return to operation 408, recursively splitting the tree.

Once the stop criteria are satisfied, then the process may prune the decision tree based on which features, including TF-IDF scores, are least predictive of attacks (operation 410). For example, if a node splits two groups of training examples that have little or no difference in observed attacks, then the node may be pruned. Additionally or alternatively, the process may determine the difference in the error function when the node is pruned. If it is greater than a threshold, then the prune may be reversed, and the node may be reinserted into the tree. If the difference in the error function is less than a threshold, then the prune may be maintained. As a result, the examples or branches that are split may be merged. The process may continue pruning nodes until removing one of the remaining nodes changes the result of the error function more than a threshold amount or a minimum threshold number of nodes remain.

Once the decision tree is built, the process may determine whether to build additional decision trees (operation 412). Multiple decision trees may be constructed in the case of random forest and gradient-boosted decision trees. For example, to generate a random forest, the training data may be split into several groups of examples. Each distinct set of training examples may be used to independently construct a separate decision tree. With gradient-boosted decision trees, several trees are constructed sequentially, with each new decision tree minimizing an error function, such as the mean squared error or logarithmic loss, of one or more previous trees in the sequence. Random forests and gradient-boosted decision trees may reduce overfitting and improve prediction accuracy of the trained ML model.

3.3 Model Evaluation and Tuning

In some embodiments, tuning engine 116 evaluates the trained ML model and tunes the ML model to optimize performance. Tuning engine 116 may measure performance using an F-measure, such as an F₁ score. The F-measure evaluates the model based on precision and recall, with the F₁ score representing a harmonic mean between the two factors. Tuning engine 116 may adjust the trained ML model parameters and hyperparameters until the F-score satisfies a threshold. Although the F-score is used in the examples herein, in other embodiments, tuning engine 116 may use other measures of accuracy to tune the ML model, such as the mean average precision (MAP) and R-Precision metrics.

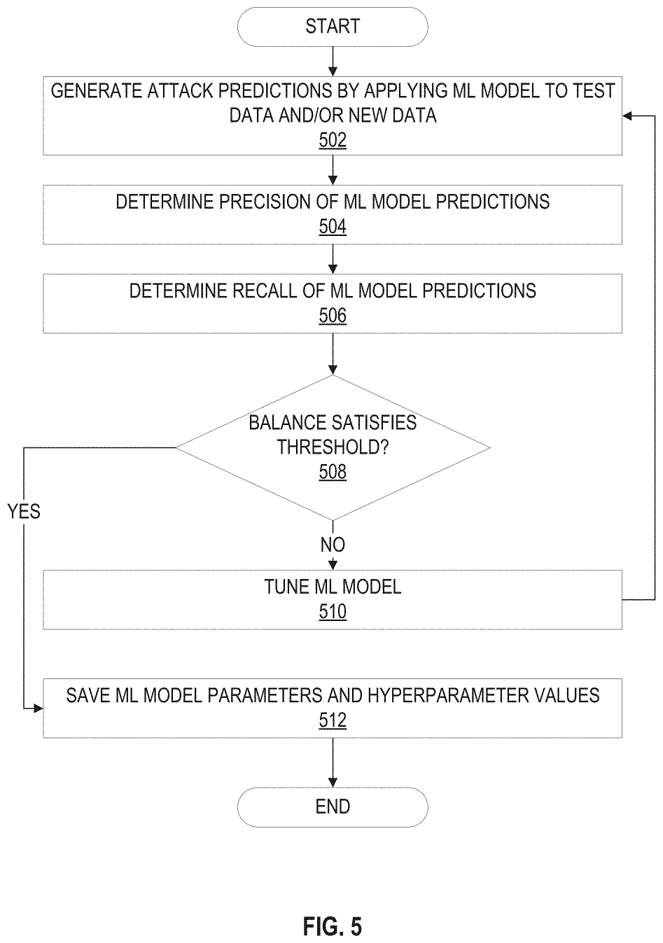

FIG. 5 illustrates an example set of operations for tuning a machine-learning model to perform real-time monitoring of network attacks in accordance with some embodiments. One or more operations illustrated in FIG. 5 may be modified, rearranged, or omitted all together. Accordingly, the particular sequence of operations illustrated in FIG. 5 should not be construed as limiting the scope of one or more embodiments.

Referring to FIG. 5, the process includes applying the trained ML model to test data and/or newly incoming data to generate attack predictions (operation 502). The process may then compare the predictions to the observed attacks to evaluate the model.

In some embodiments, the process determines the precision of the ML model predictions (operation 504). The process may compute the precision by dividing the number of accurately predicted attacks by the total number of predicted attacks, including those that were predicted but not observed. Thus, the precision may be used as a measure to indicate how effective the ML model is at avoiding false flag alerts.

In some embodiments, the process determines the recall of the ML model predictions (operation 506). The process may compute the recall by dividing the number of accurately predicted attacks by the total number of observed attacks. Thus, the recall may be used as a measure to indicate how sensitive the ML model is to detecting attacks.

In some embodiments, the process determines whether the balance between precision and recall satisfies a threshold (operation 508). For example, the process may determine whether the harmonic mean is above a threshold value. An F₁ score above 85% may indicate a good balance in some applications. However, the threshold may vary depending on the particular implementation.

If the balance does not satisfy the threshold, then the process may tune the ML model by adjusting one or more model hyperparameters and/or parameters (operation 510). Example hyperparameters and parameters may include the depth of the decision tree, the number of decision trees in a random forest, the length of a timeframe of historical log records used to compute TF-IDF scores, the minimum number of training examples per leaf, and the set of features selected to use the build the decision tree. Additionally or alternatively, tuning engine 116 may adjust other parameter values associated with the model. The process may continue adjusting values until the balance between precision and recall is satisfied.

Once a threshold balance has been achieved, the process may store the ML model parameter and hyperparameter values (operation 512). Prediction engine 118 may access the stored values to apply the ML model to newly incoming data as user activity is monitored in real-time.

4. Real-Time Threat Analysis and Detection

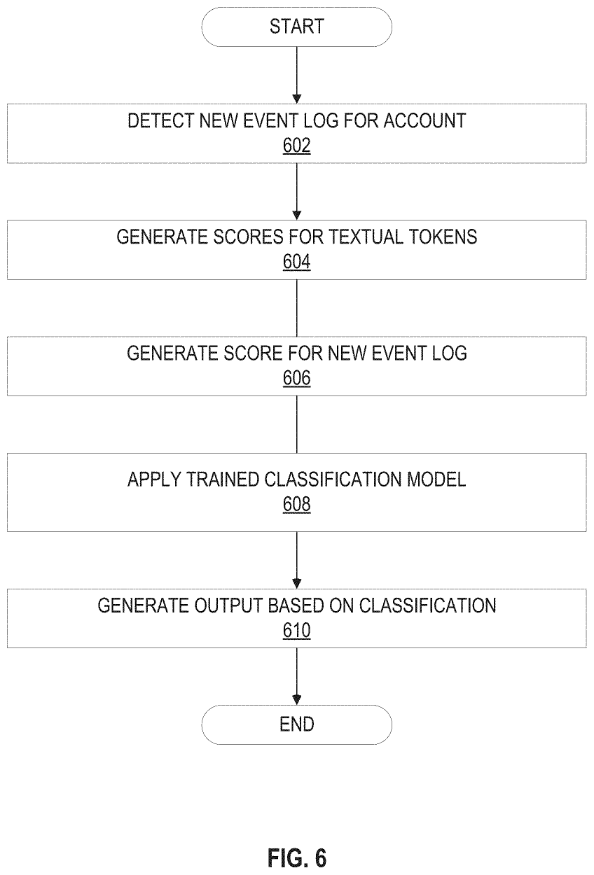

FIG. 6 illustrates an example set of operations for applying a machine-learning model to perform real-time monitoring of network attacks in accordance with some embodiments. One or more operations illustrated in FIG. 6 may be modified, rearranged, or omitted all together. Accordingly, the particular sequence of operations illustrated in FIG. 6 should not be construed as limiting the scope of one or more embodiments.

Referring to FIG. 6, the process detects a new event log for an account (operation 602). For example, the process may detect a log associated with a new login attempt or other activity associated with a user account.

Responsive to detecting the event log, the process generates scores for textual tokens within the event log (operation 604). In some embodiments, the process generates scores using TF-IDF as previously described. Thus, the score for a token may be computed as a function of the frequency it occurs within the currently detected event log relative to the frequency it occurs within historical account log records within a threshold timeframe, such as the past three to five days.

The process further generates a score for the log record based on the scores of the textual tokens included therein (operation 606). For example, the process may sum, average, or otherwise aggregate the TF-IDF scores of the textual tokens.

Once the scores have been computed, the process applies one or more trained classifiers to predict whether the new event log activity represents a current attack (operation 608). For example, the process may traverse one or more decision tress based on the computed scores. Additionally or alternatively, the process may identify the nearest cluster in a cluster-based model or a hyperplane boundary in a trained SVM model to classify the log record.

Based applied classifier, the process generates an output based on the predicted likelihood that the current account activity constitutes an attack (operation 610). In some embodiments, the output includes a label, such as Red, Amber, or Green, based on the probability of an attack and/or the predicted severity of the attack. For example, a probability or severity above a high threshold may be assigned the label Red, between a lower threshold but below the high threshold Amber, and below the lowest threshold Green. Additionally or alternatively, the output of the ML model may estimate the type of network attack occurring, such as a SQL injection attempt, directory traversal attack, or credential stuffing attack.

In embodiments where multiple decision trees are used, such as with random forests, the process may compute a final prediction by aggregating predictions of multiple trees. For example, the process may compute the mean, median, or mode prediction of the decision trees. The process may then output the aggregate result.

Table 2 illustrates an example set of sample outputs from a trained ML model in accordance with some embodiments:

TABLE 2
SAMPLE MODEL OUTPUTS

| | | | Near Real- |
|---|---|---|---|
| | Feature | Overall Score | Time |
| | Engineered | for the | Prediction |
| Raw Data | Data Scoring | Event/Log | per Event |
| “1587427199.990”, | 0.41382, 0.40118, | 5.398429999999999 | GREEN |
| CustomerSite | 0.17298, 1.0, | | |
| LoginSuccess, | 1.41045, 1.0, | | |
| 3577119, null, | 0.0, 1.0 | | |
| “Germany,” . . . | | | |
| “1587425691.237”, | 1.0, 1.731729, | 8.387889000000001 | AMBER |
| BlockedAddress, | 1.1750, 1.0, 1.0, | | |
| 1247278, null, | 1.48116, 0.0, 1.0 | | |
| “United States” . . . | | | |
| “1587417019.665”, | 1.0, 2.70428, | 11.99425 | RED |
| OpenRedirection, | 1.00652, 1.0, | | |
| 861427, Irving, | 1.41045, 1.235, | | |
| “United | 2.638, 1.0 | | |
| States” . . . | | | |

As illustrated in Table 2, the first column includes a set of raw log data, the second column identifies the feature engineered TF-IDF scores for various textual tokens in the log data, the third column identifies the overall score for the event, and the fourth column indicates the estimated label. The model output provides real-time insights into whether current account activity constitutes a network attack or not. The model output may be consumed by users, applications, and/or systems to perform appropriate prevention and mitigation actions, if warranted.

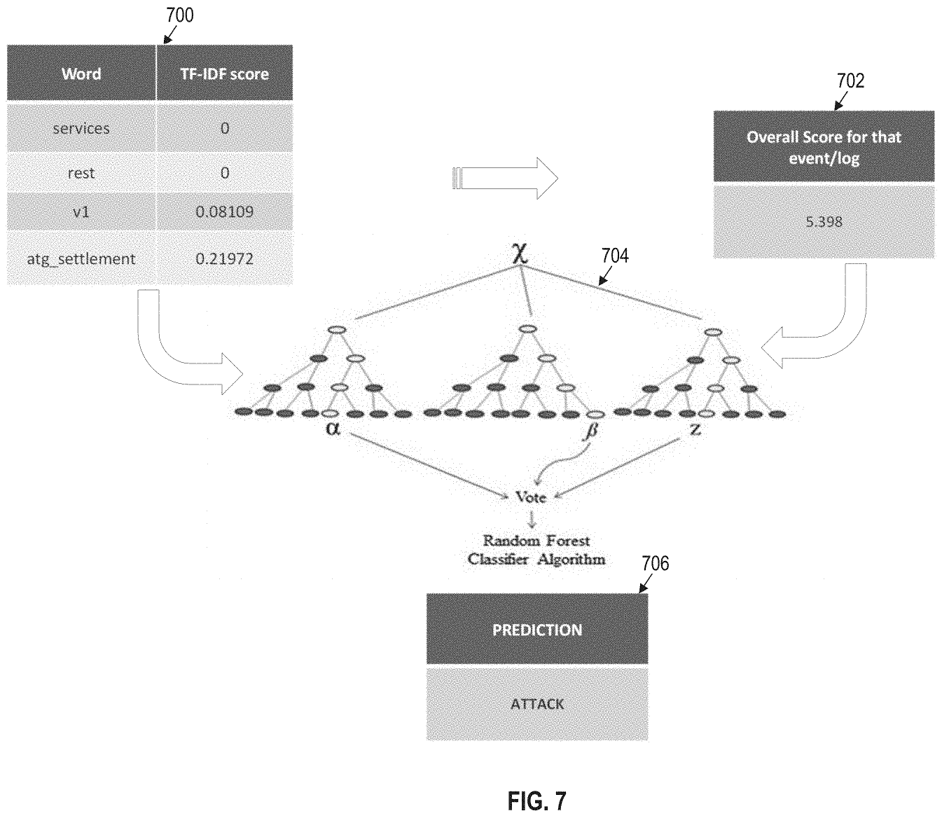

FIG. 7 illustrates an example application of a model for analyzing a network threat associated with an event in accordance with some embodiments. Table 700 identifies a set of textual tokens and scores associated with an event log. Table 702 identifies the overall score for the event log. Classification model 704 includes a set of decision trees that are traversed based on the overall score for the log event. For example, the process may determine whether to traverse to the left or right of a node based on the scores until a leaf node is reached. The leaf node may be associated with a classification label, such as Red, Amber, or Green. Classification model 704 uses a voting system whereby the majority classification is used as the final classification. In the present example, the majority of decision trees classified the log event as an attack, which is reflected in table 706.

In some embodiments, system 100 may generate and render charts, lists, and/or other objects to present to the user based on the ML model output. For example, interface engine 120 may present a list of subscribers that have experienced attacks within the last five minutes. Additionally or alternatively, interface engine 120 may highlight the top n shoppers associated with a subscriber account that have the highest severity of an attack.

Additionally or alternatively, system 100 may generate alerts to notify administrators, primary subscribers, and/or other users of network attacks. For example, system 100 may send an email and/or short message service (SMS) message to a primary subscriber if a severe attack is detected based on a shopper's log events. As another example, system 100 may send an alert message to the primary subscriber if a threshold number of subscribers have experienced a severe attack within the last five minutes or some other timeframe, as detected by the ML model.

In some embodiments, an administrator may search and filter a list of accounts based on the model predictions. For instance, the user may request to view only a list of accounts that have experienced a severe attack within a threshold timeframe, that have a threshold number of log records classified as Red, that have a predicted type of attack, and/or that have behavior that was estimated to be atypical within a given timeframe. In response to the filter request, interface engine 120 may identify the list of accounts and/or shoppers that satisfy the filter criteria and present information about the accounts to the end user, such as the account name, current status, and/or other account attributes.

5. Real-Time Attack Responses and Mitigation

In some embodiments, system 100 may perform one or more attack prevention or mitigation actions based on the output of one or more trained ML models. When an attack is detected at login, system 100 may implement responsive actions at runtime, including selectively enabling or disabling security measures on an account-by-account basis. For example, system 100 may lock an account, selectively enable two-part authentication, block an IP address, send a one-time password to a user, run a vulnerability scan, and/or perform other actions to thwart or minimize the damage of an attack in progress.

In some embodiments, system 100 compares the ML model output for newly detected account activity to one or more thresholds. If the one or more thresholds are satisfied, then system 100 may trigger one or more of the adaptive attack prevention and mitigation actions. For example, system 100 may compare the estimated number of attacks and/or severity of attacks in the past 15 minutes on an account with corresponding thresholds. If the thresholds are satisfied, then system 100 may enable one or more of the extra security measures previously mentioned. Additionally or alternatively, the type of security measures activated may vary depending on the severity, number, and/or type of network attacks that were detected by the ML model. For instance, different security measures may be deployed for SQL injection attempts than for directory traversal attacks.

In some embodiments, administrators may configure the thresholds and/or actions taken by system 100 address an attack in real-time. For example, the administrator may define a rule as follows:

If (NrOfAttackInPrevious5minutes=5) and (AlertLabelforCurrentAttack==Red)

Then SendOneTimePassword(useraccount)

System 100 may evaluate the rule based on the output of the ML models associated with the user account. If the number of detected attacks and label satisfy the criteria defined by the custom rule, then system 100 may send a one-time password to the user via email or SMS message to verify the user is active. Activity on the user account may be locked until the one-time password is received. In other embodiments, the conditions and actions defined by a rule may vary depending on the input of the administrator. Additionally or alternatively, system 100 may perform default actions or actions learned to stop attack patterns based on the ML model output.

6. Computer Networks and Cloud Networks

In some embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In some embodiments, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In some embodiments, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In some embodiments, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In some embodiments, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In some embodiments, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In some embodiments, each tenant is associated with a tenant ID. Each network resource of the multi-tenant computer network is tagged with a tenant ID. A tenant is permitted access to a particular network resource only if the tenant and the particular network resources are associated with a same tenant ID.

In some embodiments, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In some embodiments, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In some embodiments, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

7. Micro Service Applications

According to some embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally comprise a single logical executable. With microservice applications, different microservices are independently deployable as separate executables. Microservices may communicate using HTTP messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may alternatively or additionally provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In some embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

Triggers

The techniques described above may be encapsulated into a microservice, according to some embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In some embodiments, the trigger, when satisfied, might output data for consumption by the target microservice. In other embodiments, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

Actions

In some embodiments, a plugged-in microservice application may expose actions to the microservices manager. The exposed actions may receive, as input, data or an identification of a data object or location of data, that causes data to be moved into a data cloud.

In some embodiments, the exposed actions may receive, as input, a request to increase or decrease existing alert thresholds. The input might identify existing in-application alert thresholds and whether to increase or decrease, or delete the threshold. Additionally or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In some embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

8. Hardware Overview

According to some embodiments, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

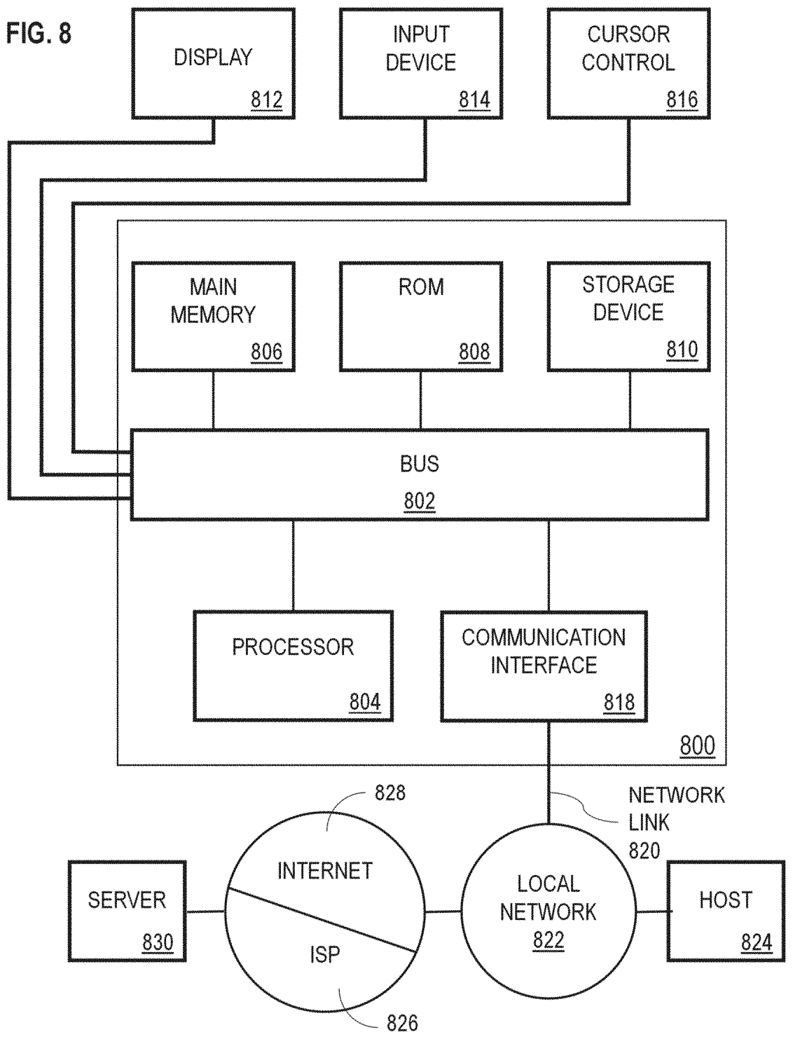

For example, FIG. 8 illustrates a computer system in accordance with some embodiments. Computer system 800 includes bus 802 or other communication mechanism for communicating information, and a hardware processor 804 coupled with bus 802 for processing information. Hardware processor 804 may be, for example, a general-purpose microprocessor.

Computer system 800 also includes main memory 806, such as a random-access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes read only memory (ROM) 808 or other static storage device coupled to bus 802 for storing static information and instructions for processor 804. Storage device 810, such as a magnetic disk or optical disk, is provided and coupled to bus 802 for storing information and instructions.

Computer system 800 may be coupled via bus 802 to display 812, such as a cathode ray tube (CRT) or light emitting diode (LED) monitor, for displaying information to a computer user. Input device 814, which may include alphanumeric and other keys, is coupled to bus 802 for communicating information and command selections to processor 804. Another type of user input device is cursor control 816, such as a mouse, a trackball, touchscreen, or cursor direction keys for communicating direction information and command selections to processor 804 and for controlling cursor movement on display 812. Input device 814 typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to some embodiments, the techniques herein are performed by computer system 800 in response to processor 804 executing one or more sequences of one or more instructions contained in main memory 806. Such instructions may be read into main memory 806 from another storage medium, such as storage device 810. Execution of the sequences of instructions contained in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid-state drive of a remote computer. The remote computer can load the instructions into its dynamic memory and send the instructions over a network line, such as a telephone line, a fiber optic cable, or a coaxial cable, using a modem. A modem local to computer system 800 can receive the data on the network line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the worldwide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

9. Miscellaneous; Extensions

Embodiments are directed to a system with one or more devices that include a hardware processor and that are configured to perform any of the operations described herein and/or recited in any of the claims below.

In some embodiments, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory computer-readable media storing instructions, which, when executed by one or more hardware processors, cause:
identifying a first set of textual tokens in a set of log records associated with an account for accessing a network service;
training, based on the set of textual tokens, a machine-learning model to identify network attacks;
detecting a new log record associated with the account for accessing the network service; and
generating, by the machine-learning model based on a second set of textual tokens in the new log record, an output that indicates whether the new log record is associated with a network attack.

2. The one or more non-transitory computer-readable media of claim 1, wherein training the machine-learning model to identify network attacks comprises converting the first set of textual tokens to numerical values.

3. The one or more non-transitory computer-readable media of claim 2, wherein the numerical values are based at least in part on a first frequency of the textual tokens in individual log records and an inverse frequency of the textual tokens across a plurality of log records.

4. The one or more non-transitory computer-readable media of claim 1, wherein training the machine-learning model to identify network attacks comprises generating a score for each respective log record in the set of log records based at least in part on what textual tokens are included in the respective log record.

5. The one or more non-transitory computer-readable media of claim 4, wherein generating the score for each respective log record comprises aggregating a set of individual scores assigned to the textual tokens included in the respective log record.

6. The one or more non-transitory computer-readable media of claim 1, wherein the machine-learning model includes one or more decision trees; wherein training the machine-learning model comprises splitting training examples from the set of log records based at least in part on scores associated with the set of textual tokens.

7. The one or more non-transitory computer-readable media of claim 6, wherein the instructions further cause: pruning the one or more decision trees based at least in part on the scores associated with the set of textual tokens.

8. The one or more non-transitory computer-readable media of claim 1, wherein the instructions further cause: adjusting at least one model hyperparameter to balance between a precision and a recall of the machine-learning model.

9. The one or more non-transitory computer-readable media of claim 1, wherein the instructions further cause: wherein the set of textual tokens include values identifying a network address, language, browser, and location associated with login attempts to the account for accessing the network service.

10. The one or more non-transitory computer-readable media of claim 1, wherein the new log record is generated based on a login attempt to the account.

11. The one or more non-transitory computer-readable media of claim 1, wherein generating the prediction comprises traversing one or more decision trees based on a set of one or more scores associated with the second set of textual tokens.

12. The one or more non-transitory computer-readable media of claim 11, wherein the scores are based at least in part on a first frequency of the second set of tokens in the new log records and a second inverse frequency of the second set of tokens in the set of log records.

13. The one or more non-transitory computer-readable media of claim 1, wherein the instructions further cause: performing one or more actions to counter a detected network attack based on the output.

14. The one or more non-transitory computer-readable media of claim 13, wherein the one or more actions are executed responsive to determining that a severity of the detected network attack satisfies a threshold.

15. The one or more non-transitory computer-readable media of claim 13, wherein the one or more actions include at least one of locking the user account, sending a user a one-time password, or enabling two-factor authentication.

16. The one or more non-transitory computer-readable media of claim 1, wherein the output includes a label that classifies the new log record.

17. The one or more non-transitory computer-readable media of claim 1, wherein the trained machine-learning model includes at least three classification labels based on at least one of a predicted likelihood that the new low record is associated with the network attack or a predicted severity of the network attack.

18. The one or more non-transitory computer-readable media of claim 1, wherein the at least three classification labels include a first label for events that have an estimated value above a first threshold, a second label for events that have an estimated value above a second threshold and below the first threshold, and a third label for events that have an estimate value below the third threshold.

19. A system comprising:
one or more hardware processors;
one or more non-transitory computer-readable media storing instructions, which, when executed by one or more hardware processors, cause performance of operations comprising:
identifying a first set of textual tokens in a set of log records associated with an account for accessing a network service;
training, based on the set of textual tokens, a machine-learning model to identify network attacks;
detecting a new log record associated with the account for accessing the network service; and
generating, by the machine-learning model based on a second set of textual tokens in the new log record, an output that indicates whether the new log record is associated with a network attack.

20. A method comprising:
identifying a first set of textual tokens in a set of log records associated with an account for accessing a network service;
training, based on the set of textual tokens, a machine-learning model to identify network attacks;
detecting a new log record associated with the account for accessing the network service; and
generating, by the machine-learning model based on a second set of textual tokens in the new log record, an output that indicates whether the new log record is associated with a network attack.
